(19) United States
(12) Patent Application Publication
(10) Pub. No.: US 2009/0168023 A1
(43) Pub. Date: Jul. 2, 2009

(54) Image display by projecting optical source onto a rotating or moving surface

(76) Inventors: Francis Wah Nam Tang, Saratoga, CA (US); Bo-In Lin, Los Altos Hills, CA (US)

Correspondence Address: BO-IN LIN, 13445 MANDOLI DRIVE, LOS ALTOS HILLS, CA, 94022, US

(21) Appl. No.: 12/380,715

(22) Filed: Mar. 2, 2009

Related U.S. Application Data
(63) Continuation-in-part of application No. 11/182,993, filed on Jul. 15, 2005, now abandoned.
(60) Provisional application No. 60/588,128, filed on Jul. 15, 2004.

(51) Int. Cl. G03B 21/00; G03B 21/60; G09G 3/36

(52) U.S. Cl. 353/13; 359/459; 345/87

(57) ABSTRACT

The present invention discloses a method for presenting an advertisement by displaying an image on a rotational or moving surface by projecting an image onto a rotational or moving surface. Since the image is not affixed onto the rotational or moving surface, the projected image can be viewed as a stationary image as the projected lights are reflected from the rotating or moving surface. Advertisements or different kinds of images can be presented on rotating surfaces such as rotating tires or rotating engine blades.

This application is a Continuation in Part (CIP) Application of a pending application Ser. No. 11/182,993 filed by a co-inventor of this Application on Jul. 15, 2005. The application Ser. No. 11/182,993 claims a Priority Filing Date of Jul. 15, 2004 benefited from a Provisional Application 60/588,128 filed previously by a co-inventor of this patent application.

### BACKGROUND OF THE INVENTION

1. Field of the Invention

This invention relates generally to a system configuration and method for arranging an optical display on a moving subject. More particularly, this invention relates to a novel system configuration and method to project an advertisement from an image source as a public display on a rotational tire or other moving objects to effectively communicate and publicize advertisement messages.

2. Description of the Prior Art

Advertisements to propagate messages for commercial products and services are still limited by the technical difficulties that the images for public display are affixed to a displaying surface. Such public display may include images and words placed on a roadside billboard, a hood or side panel of a racecar or bus, or an electronic flashing billboard. Advertisement images implemented by the conventional technologies are displayed on a display surface and typically move with the display surfaces. For example, the commercial messages painted onto the side panels of a public transit bus move when a bus driver starts to drive the bus around a city block. Due to the nature of the display images, the conventional technologies of commercial message display impose a limitation that the human eyes can no longer view the advertisements clearly when a display surface moves at a speed beyond certain speed limit, e.g., human eyes can no longer see clearly an image on a tire that rotates at a high rotational speed.

However, with the advancement of modem technologies, there are ever-increased demands for such advertisement because there are more public events attracting large crowd gathered for viewing activities that involve high-speed movements. Events such as car races draw large crowds and are often nationally televised. Advertisements are placed on engine hood, side panels or other parts of the body to display the logos of a company or product names to publicize and propagate the commercial images and the public awareness. In the meantime, using the conventional method of image display, no images are placed on the tires of the racing cars due to the facts that the tires are rotating at very high speed and advertisement images fixed to the surface on the tire would also rotate with the tires. As a result, human eyes are not able to see clearly the advertisements placed on the rotating tires.

Therefore, a need still exists in the art of advertisements and image display to provide and establish new advertisement platforms to take full advantage of the modem display technologies to resolve such limitations. Specifically, modem display technologies may be implemented to display images for reflecting from a displaying surface while the images displayed are not affixed to and moving with a moving or rotational display surface such that the above-discussed limitations can be overcome.

### SUMMARY OF THE PRESENT INVENTION

It is therefore an aspect of the present invention to provide new and improved display systems to display commercial messages wherein the images and the messages are not painted or attached to a display surface. Instead the advertisement images are generated and projected from an image source and the projected optical images are reflected from a displaying surface. By removing the images as images affixed to a displaying surface and replacing the image display by projecting the image from an optical source onto a displaying surface. The images displayed on the displaying surface are viewed by human eyes as optical reflections from the displaying surface and thus are not substantially affected by instantaneous motion of the displaying surface.

Specifically, it is further an aspect of the present invention to provide new image display systems to project advertisement messages on a rotational surface by controlling an optical source to project an advertisement message on a moving surface observable by human eyes such that the projected advertisement message can be displayed not affected by a movement of the moving surface.

Another aspect of the present invention to provide new image display systems to project advertisement messages on a display surface created by projecting and spreading light reflecting particles such as water droplets or other light reflective particles and by controlling an optical source to project an advertisement message on the display surface observable by human eyes such that the projected advertisement message can be displayed not limited by requiring a permanent display surface that may not be available.

Another aspect of the present invention to provide new image display systems to project advertisement messages and images on a display surface such as a liquid crystal display (LCD) surface by controlling and changing the advertisement messages and images by controlling a display image source that may be disposed locally or remotely through a wireless signal control.

Briefly, in a preferred embodiment, the present invention discloses an image source disposed on a non-rotational part of a motor vehicle for projecting an optical image to a rotational part for display an image thereon. In a preferred embodiment, the optical source includes a laser image source for projecting visible laser beam for displaying the image.

In another preferred embodiment, the present invention discloses an image display system for displaying an image. The image display system includes a spreader for spreading a surface of reflective particles for projecting and displaying an image on the surface of the reflective particles. In an exemplary embodiment, the spreader is disposed on a moving vehicle for displaying an image on the surface of the reflective particles near the moving vehicle. In another exemplary embodiment, the spreader spreading water droplets as the reflective particles for projecting and displaying an image on the surface formed by the water droplets.

In another preferred embodiment, the present invention disclose an image display system for displaying an image on a moving vehicle having a part covered by an image display surface controllable by an image source to display different images on the image display surface. In an exemplary embodiment, the image source receives a remotely controllable signal to control and change the images displayed on the image display surface disposed on the moving vehicle. In an exemplary embodiment, the image display surface further comprises a liquid crystal display (LCD) surface controllable to display different images according to signals received from the image source.

In a preferred embodiment, this invention further discloses method for displaying an advertisement image and the method includes a step of projecting a display image from an image source and displaying the display image on a moving surface. The display image as projected from the image source is visible and recognizable by a viewer without being distorted or affected by the moving surface. In another preferred embodiment, the display image source is controlled by an image display controller to display the image with multiple color schemes and also for displaying the image with specific controlled timings to produce special advertisement and display effects.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIGS. 1A and 1B are a top view and a side cross sectional view of a wheel supporting a tire of this invention wherein an image source is mounted on a station shaft of the wheel for displaying an image on the wheel.

FIG. 2 is a perspective view of a racecar with image sources mounted on different parts of the car for projecting and displaying advertisements on the front or rear ties.

FIG. 3 is a functional block diagram for controlling the image source for projecting and displaying advertisement on different parts of a vehicle including tires.

### DETAILED DESCRIPTION OF THE PREFERRED EMBODIMENT

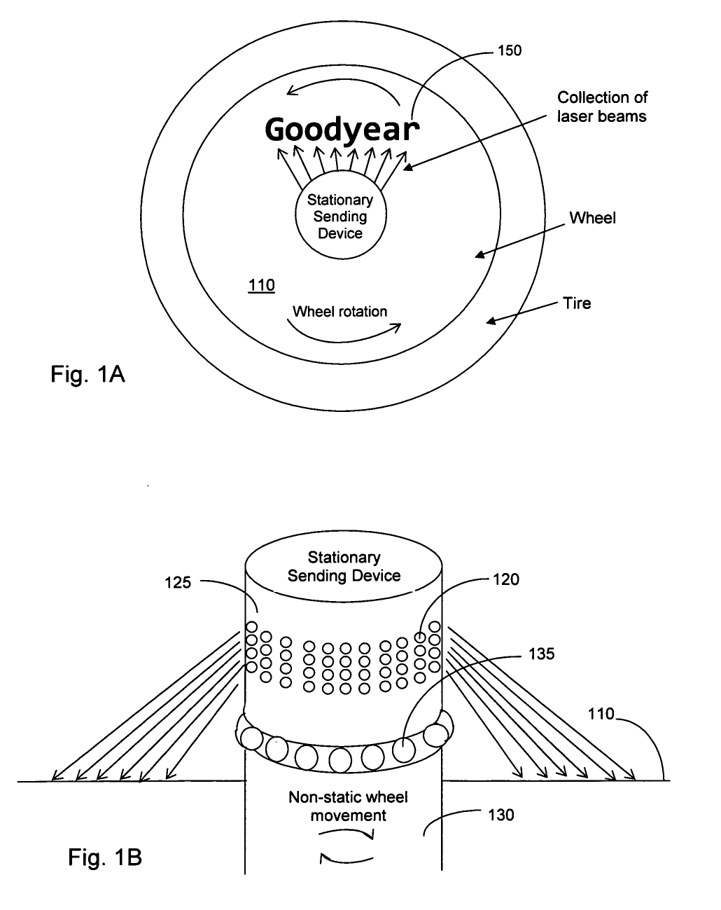

FIGS. 1A and 1B are a top view and a side cross sectional views of an image display system 100 of this invention for projecting and displaying images on a rotational wheel surface 110. The image display system includes an image source 120 disposed on a stationary cylindrical surface 125. The stationary cylindrical surface is mounted onto a rotational wheel shaft 130 with bearings 135 to isolate the stationary cylindrical surface 125 from the rotational wheel shaft 130 such that the stationary cylindrical surface 125 is not rotating with the rotational shaft 130. The image source 120 includes a plurality of laser beam source to project an optical image onto the rotational wheel surface 110. Since the image source 120 is stationary and rotating with the wheel, the images projected onto the wheel surface 110 are reflected from the rotating wheel surface as non-rotational images 150, e.g., Goodyear, to a viewer as that shown in FIG. 1A. A rotational surface, e.g., the wheel surface 110, is now useful for displaying a commercial message on a racecar wheel as an advertisement for an advertisement sponsor.

In an alternate embodiment, some of the light sources 120 may also implemented with a liquid droplet injector, e.g., a reflective particle spreader, to spread liquid droplets, e.g., water droplets, to cover the wheel 110. The liquid droplets that temporally covering the rotation wheel will provide a reflective surface to reflect the images projected from the light sources 120. The display would have an effect similar to a color fountain display on the wheel.

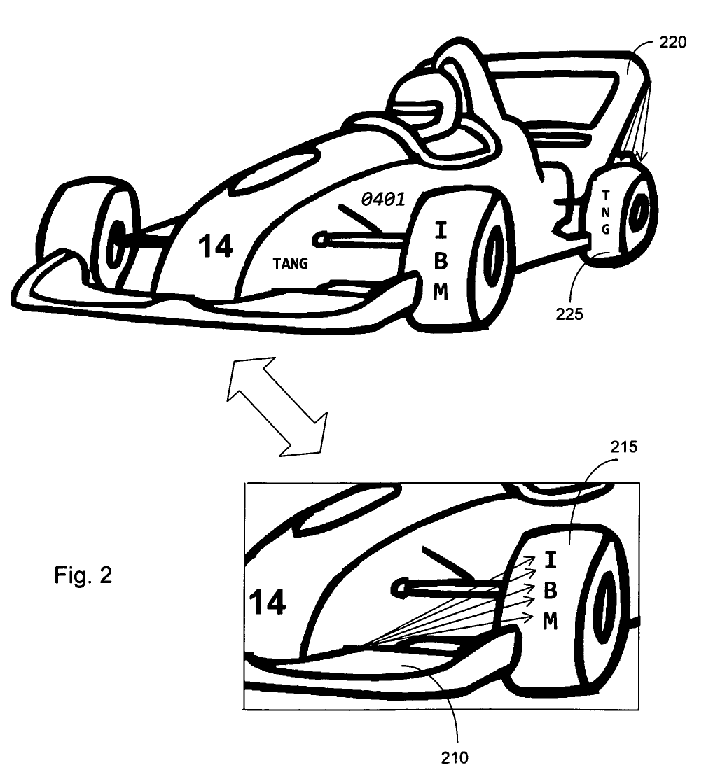

FIG. 2 shows another embodiment, for displaying advertisements on the surface of a tire of a racecar. As shown in FIG. 2, there are front and rear fenders 210 and 220 respectively. These fenders are near the front and rear tires 215 and 225 respectively. Image sources can be placed on the fenders 210 and 220 to project advertisement images onto the surface of the front and rear tires 215 and 225, e.g., IBM and Mobile. The advertisements projected onto the tire surface will not rotate with the rotating tires and would be visible to large crowds attending the car race events.

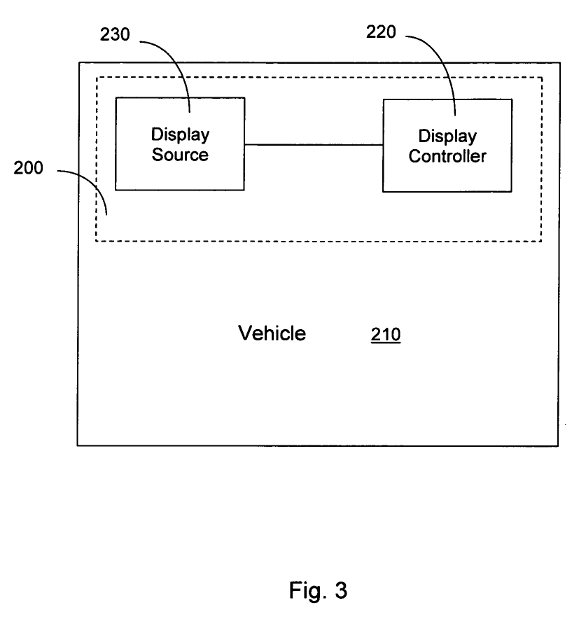

Furthermore, in a preferred embodiment, the part 14 on the top surface of the race car may be covered with an image display surface such as a liquid crystal display surface (LCD). The image display surface is controllable by receiving different image display signals from an image source 230 (shown in FIG. 3 below) to control and display different images. Therefore, this invention discloses an image display system for displaying an image on a moving vehicle, such as a race car shown in FIG. 2, having a part covered by an image display surface 14 controllable by an image source to display different images on the image display surface. In an exemplary embodiment, the image source receives a remotely controllable signal to control and change the images displayed on the image display surface disposed on the moving vehicle. In a specific embodiment, the image display surface further comprises a liquid crystal display (LCD) surface controllable to display different images according to signals received from the image source.

FIG. 3 is a functional block diagram for showing an optical image display system 200 installed on a vehicle 210 that includes a image display controller 220 for controlling an image display source 230. The control and display data signals may be transmitted to the image display source either through wired electrical connections or via wireless signal transmission. The image display source 230 has a processor to execute different display functions according to data and command signals receive from the image display controller 220. The image display controller 220 may send commands and data to control the color schemes and/or timing of image display on the rotating surface of the tire with specially designed color schemes and timings to further increase the advertisement effects of the display images. The image display controller 220 further includes a transceiver to receive and transmit wireless signals from and to remote image transmission and control transceivers for controlling and displaying different images by controlling the display source 220.

According to the drawings and above descriptions, this invention discloses an optical display system that includes an image projecting source disposed near a tire of a vehicle for projecting and displaying an image on a rotating surface of the tire. In a preferred embodiment, the image projecting source is disposed on a stationary shaft for supporting and linking the tire. In another preferred embodiment, the image projecting source is disposed on a stationary part of the vehicle for projecting and displaying an image on the rotating surface of the tire. In another preferred embodiment, the image projecting source further includes a laser image projecting source for projecting and displaying a laser image on a side surface of the rotating tire. In another preferred embodiment, the image projecting source further projects an image to a rotating side surface of the tire for displaying an image on the rotating side surface of the tire. In another preferred embodiment, the optical display system further includes an image display controller for controlling the image projecting source for projecting and display an image on the rotating surface of the tire. In another preferred embodiment, the optical display system further includes an image display controller provided for receiving wireless data and control signals for controlling the image projecting source for projecting and display an image on the rotating surface of the tire. In another preferred embodiment, the image projecting source further includes an image source of multiple colors. In another preferred embodiment, the optical display system further includes an image display controller with a display time controller for controlling a timing of the image projecting source for projecting and display an image on the rotating surface of the tire. In another preferred embodiment, the optical display system further includes an image display controller with a display color controller for controlling a color scheme of the image projecting source for projecting and display an image on the rotating surface of the tire.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An image display system comprising:
an image display surface disposed on a surface covering a part of a moving vehicle for receiving image signals to change images displayed thereon.

2. The image display system of claim 1 wherein:
said image display surface further comprising a liquid crystal display (LCD) surface.

3. The image display system of claim 1 further comprising:
a display controller for controlling and changing images displayed on the image display surface.

4. The image display system of claim 1 further comprising:
a display controller comprising a transceiver for receiving wireless image signals to control and change images displayed on the image display surface.

5. An image display system comprising:
an image display surface spreader for spreading a surface of light reflective particles for projecting and displaying images on said surface of light reflective particles.

6. The image display system of claim 5 wherein:
said image display surface spreader spreading said surface of light reflective particles near a moving vehicle.

7. The image display system of claim 1 further comprising:
said image display surface spreader spreading water droplet to form said surface of light reflective particles near a moving vehicle.

8. The image display system of claim 5 further comprising:
a display controller for controlling and changing images displayed on the image display surface.

9. The image display system of claim 5 further comprising:
a display controller comprising a transceiver for receiving wireless image signals to control and change images displayed on the image display surface.
